(19) United States
(12) Patent Application Publication
(10) Pub. No.: US 2008/0236767 A1
(43) Pub. Date: Oct. 2, 2008

(54) Roman shade apparatus

(76) Inventor: Ian Bender, Burlington, VT (US)

Correspondence Address: Ian Bender, 208 Flynn Avenue, Burlington, VT, 05401, US

(21) Appl. No.: 12/079,833

(22) Filed: Mar. 28, 2008

Related U.S. Application Data
(60) Provisional application No. 60/920,652, filed on Mar. 29, 2007.

(51) Int. Cl. E06B 9/24

(52) U.S. Cl. 160/236

(57) ABSTRACT

A “Roman Shade” apparatus featuring a roller mechanism roller mechanism for taking up and releasing the operating cords attached to the rear of the material making up the shade. The roller mechanism in turn comprises a bracket supporting the roller and serves as the head rail for the shade apparatus. The “Roman Shade” apparatus of the present invention thus may be operated in the same manner as a conventional roll-up shade.

### CROSS-REFERENCE TO RELATED APPLICATION

This application claims priority based upon my copending Provisional Application Ser. No. 60/920,652; filed Mar. 29, 2007.

### BACKGROUND OF THE INVENTION

1. Field of the Invention

The present invention relates generally to window shades, and more particularly, to a roll-up window shade having the look and a appearance of a so-called “Roman Shade.”

2. Description of the Prior Art

Window shades comprising a flexible sheet attached at one end of a roll-up mechanism are notoriously well known. Also well known is a so-called “Roman Shade” which, when raised usually by operation of a suitable cord system or the like, creates a series of cascading overlapping folds of the shade material thereby giving an aesthetically elegant appearance.

Various Roman Shade constructions are disclosed in U.S. Pat. Nos. 7,124,802, 5,566,735; and 5,273,096, each of which is incorporated herein and made part of this specification by this reference. As indicated by these prior art references, a system of cords is required to raise and lower the shade material to a desired position. The use of such cords is unsightly and detracts from the appearance of the shade.

It would be extremely advantageous if a Roman Shade apparatus could be designed to roll up and down on a cord assembly that was not visible to the naked eye. To achieve this desideratum, the present invention, briefly described provides a “Roman Shade” apparatus featuring a roller mechanism for taking up and releasing the operating cords attached to the rear of the material making up the shade. The roller mechanism in turn comprises a bracket supporting the roller and serves as the head rail for the shade apparatus. The “Roman Shade” apparatus of the present invention thus may be operated in the same manner as a conventional roll-up shade.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved Roman Shade apparatus which has all of the advantages of the prior art and none of the disadvantages.

It is another object of the present invention to provide a new and improved Roman Shade apparatus which may be easily and efficiently manufactured and marketed.

It is a further object of the present invention to provide a new and improved Roman Shade apparatus which is of durable and reliable construction.

An even further object of the present invention is to provide a new and improved Roman Shade apparatus which is susceptible of a low cost of manufacture with regard to both materials and labor, and which accordingly is then susceptible of low prices of sale to the consuming public, thereby making such weight Roman Shade apparatus available to the buying public.

Still yet a further object of the present invention is to provide a new and improved Roman Shade apparatus in which the cord system for operating same normally is not visible.

Still another object of the present invention is to provide a new and improved Roman Shade apparatus that may be operated in essentially the same manner as a conventional roll-up shade.

Yet another object of the present invention is to provide a new and improved Roman Shade apparatus which includes a roller mechanism for taking up and releasing operating cords attached to the rear thereof.

Even another object of the present invention is to provide a new and improved Roman Shade apparatus in which the roller mechanism of the shade assembly comprises a bracket supporting the roller and serving the dual purpose of being the head rail for the shade apparatus.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated at least one preferred embodiment of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the shade apparatus of the invention in a down or window covering condition.

FIG. 2 is another front view of the embodiment of FIG. 1 showing the shade in an up condition or window exposing condition.

FIG. 3 is a side view of the embodiment of FIG. 1 taken along line 3-3 thereof.

FIG. 4 is a side view of the embodiment of FIG. 2 taken along line 4-4 thereof.

FIG. 5 is a rear view of the embodiment of FIG. 1.

FIG. 6 is a rear view of an alternatively preferred embodiment of the shade according to the present invention showing an added pull cord assembly.

### DESCRIPTION OF THE PREFERRED EMBODIMENT

With reference to the drawings, a new and improved Roman Shade apparatus embodying the principles and concepts of the present invention will be described.

Turning to FIGS. 1-5, there is shown a first embodiment of the Roman Shade apparatus of the invention generally designated by reference numeral 10. In each of the figures, reference numerals are shown that correspond to like reference numerals that designate like elements shown in other figures.

As is well known in the art of window coverings, a “Roman Shade” is a type of shade normally comprising a flexible or pliable material (e.g. cotton, vinyl, or any other soft type of window covering material), a head rail, and a cord control system for raising and lowering the shade relative to the head rail. When the shade is raised it creates cascading loops of overlapping folds of material giving an aesthetically elegant appearance. However, when the shade is lowered it simply displays a flat piece of material hanging in front of and covering a window. Various Roman Shade constructions are disclosed in U.S. Pat. Nos. 7,124,802, 5,566,735; and 5,273,096, each of which is incorporated herein and made part of this specification by this reference.

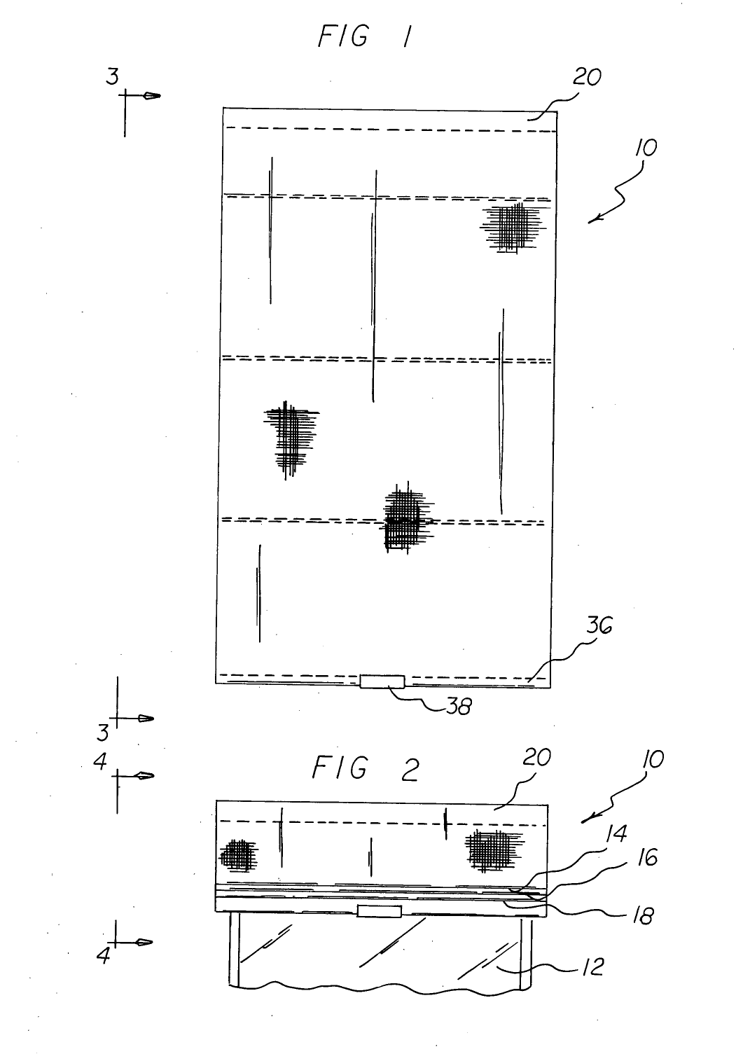

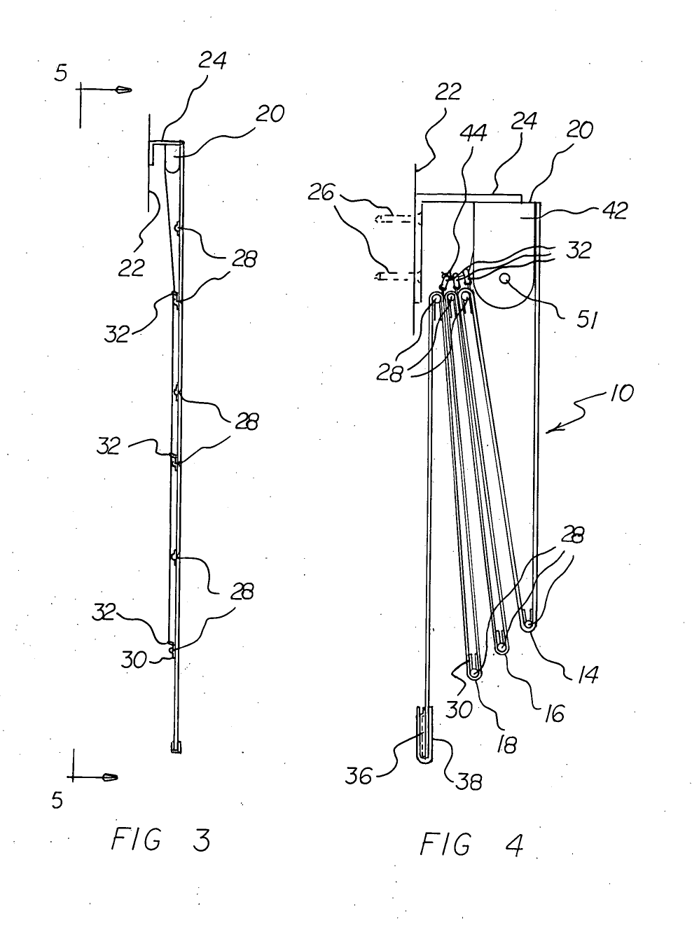

As shown in FIG. 1, the Roman Shade apparatus 10 of the present invention completely covers its corresponding window in the fully down or window covering condition whereas FIG. 2 shows the shade 10 in a fully raised condition exposing window 12. When in the raised condition, shade apparatus 10 forms the characteristic cascading folds 14, 16, 18 (FIGS. 2 and 4) of a “Roman Shade.” The top portion of shade apparatus 10 is suitably attached to a transversely extending head rail assembly 20 which, in turn, may be suitably attached to a wall 22 above the window 12 by a suitable bracket assembly 24 and fasteners 26 (FIGS. 3 and 4).

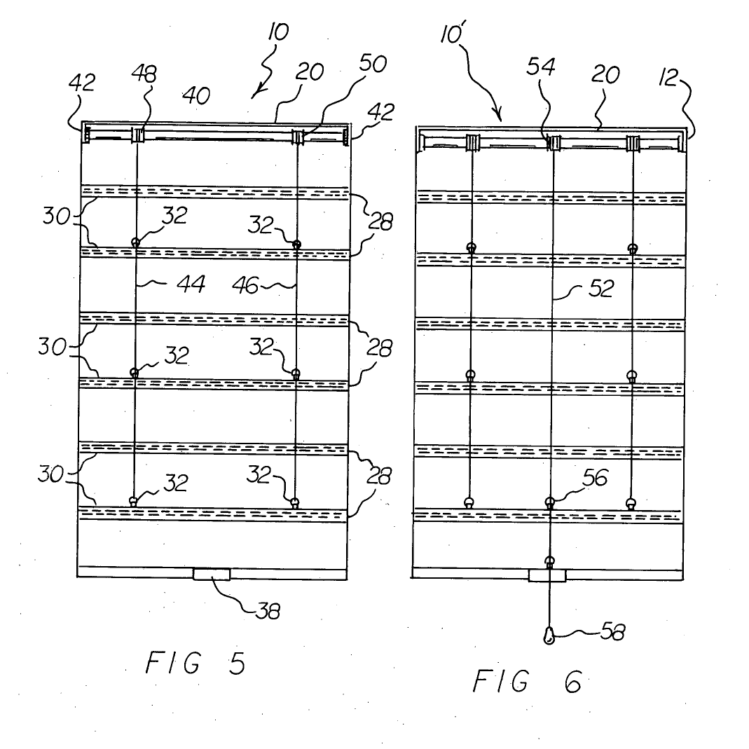

As best seen in FIG. 5, on the rear surface of shade apparatus 10 is suitably disposed and affixed a series of longitudinally spaced transverse rods or supports 28 suitably sewn in position by fabric flaps 30 or the like and which define the folds 14, 16, and 18, and which provide support for the cord control assembly as will be discussed in more detail below. In the preferred embodiment of FIGS. 1-5, there are provided six (6) such evenly spaced rods or supports 28 substantially as shown. Attached to the second, fourth and sixth rod supports 28 is a pair of transversely spaced cord loops 32 substantially arranged as depicted with each loop being suitably attached to its corresponding rod covering flap 30 as by sewing, for example. If desired, a transverse edging support 36 and handle 38 may be provided to finish the bottom edge of the shade apparatus 10.

The cord control assembly comprises a transverse axle assembly 40 which is suitably rotatably mounted and supported on and between a pair of opposed downward extensions or ears 42 on head rail 20 immediately behind the top portion of shade apparatus 10, and a pair of downwardly extending cords 44 and 46. Each cord 44 and 46 is attached at its bottom end to a corresponding loop 32 (as by tying) in the sixth row of rod supports, and at its top end to a corresponding spool 48, 50 affixed to axle 40. The cords 44, 46 also pass freely through the loops 32 in the second and fourth row of rod supports whereas axle 40 is adapted to rotate about transverse axis 51.

It will be appreciated from the foregoing arrangement that when the axle 40 is caused to rotate about its axis 51, cords 44 and 46 will be wound upon spools 48, 50 respectively, causing the shade to be raised and to assume the “Roman Shade” configuration of FIGS. 2 and 4. Release of the axle 40 will cause the spools to rotate in the opposite direction returning the shade apparatus to the down position of FIGS. 1, 3 and 5 or to any position therebetween. Release of the axle from its lock may be achieved simply by giving the bottom of the shade a slight tug as will be explained further below.

Turning to the alternatively preferred embodiment of FIG. 6, optionally, a center cord 52 and spool 54 may be added together with a center loop 56 attached to the rod support in the sixth row as substantially shown to provide an auxiliary handle 58 for operating the shade apparatus as will occur to those of ordinary skill in the art.

It will further be appreciated that in accordance with the present invention, a suitable drive motor (not shown) is included in one end of the axle 40 whereupon the axle is caused to rotate under the influence of a coil spring in response to a slight torque or tension being applied to the spools 48, 50 or 54. This is quite similar to the drive motors used in conventional “roll-up” shades where with only a slight tug on the bottom of the shade from any height of the shade the motor is caused to drive the axle thereby fully retracting the shade to the top or raised position, or where pulling down on the shade causes the shade to move downward until released whereupon the shade (axle) stops in that 10 position. Until the present invention, no such drive motors have been used in combination with a “Roman Shade” apparatus. The term “roller mechanism” herein encompasses the axle 40 and its drive motor included in one end thereof (not shown).

Another advantage of the present invention is that the normal pull cords visible and dangling in front of a conventional Roman Shade are dispensed with entirely. Such cords are unsightly and detract from the elegant appearance of a “Roman Shade.” Also with the optional embodiment of the invention, the shade can be raised to a position greater than the height of the operator and then pulled down by means of the optional center cord and handle.

The components of the shade apparatus of the invention can be made from inexpensive and durable metal, fabric and plastic materials.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use. For example, in lieu of weight sensors in the microwave turntable, other sensors such as photocells, may used to sense the presence of an article on a pie-shaped 10 sector or plurality of sectors of the turntable through suitable optical transmission means provided in the turntable pie-shaped sectors as will occur to those of ordinary skill in the art.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by LETTERS PATENT of the United States is as follows:

1. A window covering apparatus of the Roman Shade type having cascading overlapping transverse folds when in the raised or partially raised condition, said apparatus comprising:
a roller assembly,
a shade member attached to the roller assembly, and
an operating member for raising and lowering the shade member relative to the roller assembly in response to operation of the roller assembly.

2. The apparatus of claim 1 wherein said operating member comprises at least one longitudinally extending cord member attached between said roller assembly and said shade member.

3. The apparatus of claim 2 wherein said shade member has a first side and a second side and a remote end portion with respect to sad roller assembly, and said cord member is attached between said roller assembly and said remote end portion on said first side of said shade member whereupon said cord member is not visible when viewing said second side of said shade member.

4. The apparatus of claim 3 wherein said shade member has a plurality of spaced loops affixed to said first side thereof, said spaced loops extending between said roller mechanism and said shade member end portion, and wherein said cord member is affixed to the loop in said plurality of loops proximal to said shade member remote end portion, and wherein said cord member slidingly extends freely through the remaining loops in said plurality of spaced loops.

5. The apparatus of claim 4 wherein said roller assembly includes an axle adapted to rotate in response to a slight torque or tension being applied to said attached shade member thereby to drive said axle sufficiently to cause said cord member to retract said shade to a raised position.

6. The apparatus of claim 5 wherein said shade member remote end portion has an auxiliary handle attached thereto.
